(19) United States
(12) Patent Application Publication
(10) Pub. No.: US 2016/0209701 A1
(43) Pub. Date: Jul. 21, 2016

(54) COLOR FILM SUBSTRATE, LIQUID CRYSTAL DISPLAY PANEL AND DISPLAY DEVICE

(71) Applicants: Boe Technology Group Co., Ltd., Beijing (CN); Hefei Xinsheng Optoelectronics Technology Co., Ltd., Anhui (CN)

(72) Inventors: Peipei Qin, Beijing (CN); Shengping Du, Beijing (CN); Yu Yang, Beijing (CN); Peilei Xia, Beijing (CN)

(21) Appl. No.: 14/742,976

(22) Filed: Jun. 18, 2015

(30) Foreign Application Priority Data
Jan. 21, 2015 (CN) 201510030425.1

(51) Int. Cl. G02F 1/1335; G02B 5/20

(52) U.S. Cl. CPC G02F 1/133514; G02B 5/201; G02F 1/133512

(57) ABSTRACT

The embodiments of the present invention provide a color film substrate, a liquid crystal display panel and a display device; wherein the color film substrate comprises: a basal substrate, a black matrix and a plurality groups of color filters located on the basal substrate, and a planarization layer located on the black matrix and the color filters; each group of color filters comprises a red filter, a green filter, a blue filter and a blank region defined by the black matrix; the planarization layer filled in the blank region serves as a white filter; wherein the color film substrate further comprises: at least one linear height compensation component located in the blank region; the height compensation component and the black matrix are arranged in a same layer. In this manner, the arrangement of the white filter does not require adding one more composition process; moreover, at least one linear height compensation component located in the blank region is added, while the height compensation component and the black matrix are arranged in a same layer, thus an additional composition process is not required; furthermore, the height compensation component can serve as a diversion dike to enhance a flow energy in the horizontal direction within the blank region for the planarization layer, thereby simplifying the manufacture process of the color film substrate with a red filter, a green filter, a blue filter and a white filter, while improving the flatness of the planarization layer.

### RELATED APPLICATIONS

The present application claims the benefit of Chinese Patent Application No. 201510030425.1, filed Jan. 21, 2015, the entire disclosure of which is incorporated herein by reference.

### FIELD OF THE INVENTION

The present invention relates to the technical field of display, in particular to a color film substrate, a liquid crystal display panel and a display device.

### BACKGROUND OF THE INVENTION

A liquid crystal display panel mainly comprises a color film substrate, an array substrate and a liquid crystal layer between these two substrates, wherein a black matrix and a color filter are arranged on a surface of the color film substrate facing the liquid crystal layer.

In an existing color film substrate, as shown in FIG. 1a and FIG. 1b, the color film substrate comprises: a basal substrate 101; and a black matrix 102, a color filter 103 and a planarization layer 104, which are arranged on the basal substrate 101 in sequence; wherein the color filter 103 comprises a red (R) filter, a green (G) filter, a blue (B) filter and a white (W) filter. The manufacture process of the W filter in the color film substrate shown in FIG. 1 is same with that of the R/G/B filter; in the color film substrate shown in FIG. 1b, the planarization layer 104 serves as the W filter. Compared with a color film substrate with a RGB structure, the color film substrate with a RGBW structure has a higher transmittance; therefore, by applying the color film substrate with a RGBW structure into a liquid crystal display panel, the power consumption of the liquid crystal display panel can be reduced.

The manufacture process of the color film substrate shown in FIG. 1a comprises: firstly, forming a black matrix pattern on a basal substrate; then, forming RGBW patterns respectively with a four-time composition process; finally, forming a planarization layer on the black matrix pattern and the RGBW patterns. The manufacture process of the color film substrate shown in FIG. 1a needs a five-time composition process, the manufacture process is relatively complex, and the production cost is relatively high. The manufacture process of the color film substrate shown in FIG. 1b comprises: firstly, forming a black matrix pattern on a basal substrate; then, forming RGB patterns respectively with a three-time composition process; finally, forming a planarization layer on the black matrix pattern and the RGB patterns. Though the manufacture process of the color film substrate shown in FIG. 1b can eliminate one composition process, the flatness of the planarization layer in the color film substrate shown in FIG. 1b is relatively poor, and there is a problem of a big segment difference (as indicated by H in FIG. 1b, i.e., the difference between the surface height of the planarization layer 104 at W filter and the surface height of the planarization layer 104 at R/G/B filter), thereby affecting the display quality of the liquid crystal display panel.

Hence, it is desired to simplify the manufacture process of the color film substrate with a RGBW structure while improving the flatness of the planarization layer.

### SUMMARY OF THE INVENTION

To this end, the embodiments of the present invention provide a color film substrate, a liquid crystal display panel and a display device, to simplify the manufacture process of the color film substrate with a RGBW structure while improving the flatness of the planarization layer.

Therefore, an embodiment of the present invention provides a color film substrate, wherein the color film substrate comprises: a basal substrate, a black matrix and a plurality groups of color filters located on the basal substrate, and a planarization layer located on the black matrix and the color filters; each group of color filters comprises a red filter, a green filter, a blue filter and a blank region defined by the black matrix; the planarization layer filled in the blank region serves as a white filter; wherein the color film substrate further comprises:

at least one linear height compensation component located in the blank region; the height compensation component and the black matrix are arranged in a same layer.

In a possible implementation, in the color film substrate provided by the embodiment of the present invention, the orthographic projections of the red filter, the green filter, the blue filter and the blank region on the basal substrate are all rectangles and are arranged in an array;

one rectilinear height compensation component is provided in the blank region; the orthographic projection of the rectilinear height compensation component on the basal substrate is parallel to two opposite sides in the orthographic projection of the blank region on the basal substrate.

In a possible implementation, in the color film substrate provided by the embodiment of the present invention, the length of the rectilinear height compensation component is equal to the length of these two opposite sides.

In a possible implementation, in the color film substrate provided by the embodiment of the present invention, the blank region is divided into two regions with the same area by the rectilinear height compensation component.

In a possible implementation, in the color film substrate provided by the embodiment of the present invention, the orthographic projections of the red filter, the green filter, the blue filter and the blank region on the basal substrate are all rectangles and are arranged in an array;

two rectilinear height compensation components perpendicular to each other are provided in the blank region; the orthographic projections of these two rectilinear height compensation components on the basal substrate are respectively parallel to two adjacent sides in the orthographic projection of the blank region on the basal substrate.

In a possible implementation, in the color film substrate provided by the embodiment of the present invention, among these two rectilinear height compensation components: the length of one rectilinear height compensation component is equal to the length of a side parallel to the rectilinear height compensation component; the length of the other rectilinear height compensation component is equal to the length of a side parallel to the other rectilinear height compensation component.

In a possible implementation, in the color film substrate provided by the embodiment of the present invention, the blank region is divided into four regions with the same area by these two rectilinear height compensation components.

In a possible implementation, in the color film substrate provided by the embodiment of the present invention, the width of the height compensation component is greater than or equal to 6 rim.

In a possible implementation, in the color film substrate provided by the embodiment of the present invention, the height of the height compensation component is same with the height of the black matrix.

An embodiment of the present invention also provides a liquid crystal display panel, wherein the liquid crystal display panel comprises: the color film substrate according to any one of the above mentioned embodiments, an array substrate arranged opposite to the color film substrate, and a liquid crystal layer between the color film substrate and the array substrate.

An embodiment of the present invention further provides a display device, wherein the display device comprises the liquid crystal display panel according to the above mentioned embodiment.

The embodiments of the present invention provide a color film substrate, a liquid crystal display panel and a display device; wherein the color film substrate comprises: a basal substrate, a black matrix and a plurality groups of color filters located on the basal substrate, and a planarization layer located on the black matrix and the color filters; each group of color filters comprises a red filter, a green filter, a blue filter and a blank region defined by the black matrix; the planarization layer filled in the blank region serves as a white filter; wherein the color film substrate further comprises: at least one linear height compensation component located in the blank region; the height compensation component and the black matrix are arranged in a same layer. In this manner, the arrangement of the white filter does not require adding one more composition process; moreover, at least one linear height compensation component located in the blank region is added, while the height compensation component and the black matrix are arranged in a same layer, thus an additional composition process is not required; furthermore, the height compensation component can serve as a diversion dike to enhance a flow energy in the horizontal direction within the blank region for the planarization layer, thereby simplifying the manufacture process of the color film substrate with a red filter, a green filter, a blue filter and a white filter, while improving the flatness of the planarization layer.

### BRIEF DESCRIPTION OF THE DRAWINGS

FIG. 1a and FIG. 1b respectively are structural schematic diagrams of color film substrates in the prior art;

FIG. 2 is a structural schematic diagram of a color film substrate provided by an embodiment of the present invention;

FIG. 3 is a section view of FIG. 2 along the AA direction; and

FIG. 4 is a structural schematic diagram of another color film substrate provided by an embodiment of the present invention.

### DETAILED DESCRIPTION OF THE INVENTION

In the following, the implementations of the color film substrate, the liquid crystal display panel and the display device provided by the embodiments of the invention will be described clearly and completely in connection with the drawings.

The shapes and thickness of the film layer in the drawings do not reflect the real scale of the color film substrate, but to schematically illustrate the content of the invention.

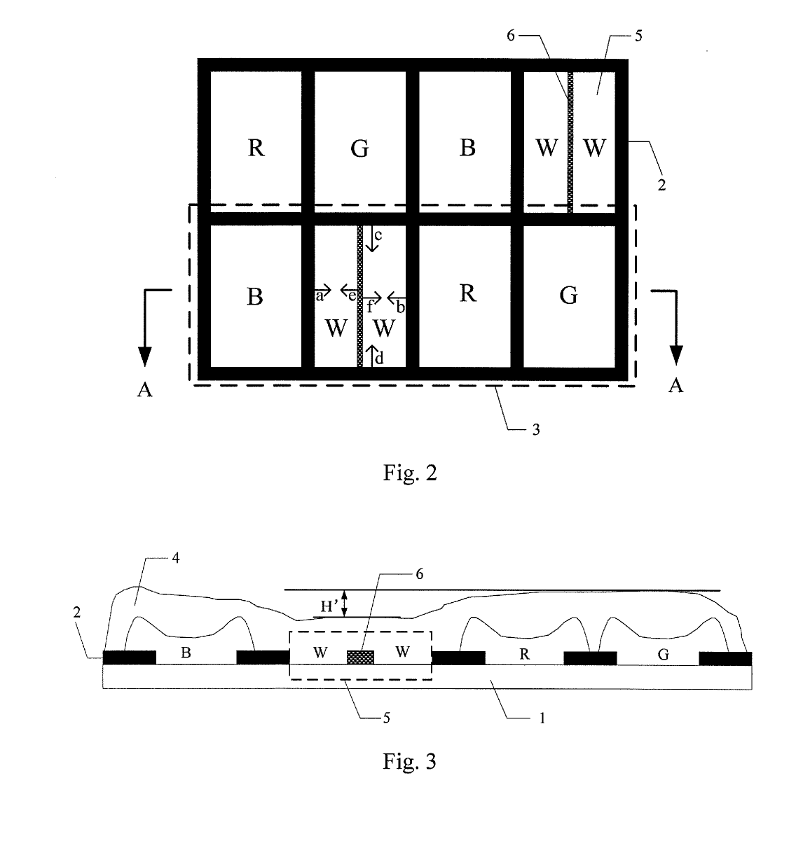

A color film substrate provided by an embodiment of the present invention is shown in FIG. 2 and FIG. 3, wherein FIG. 3 is a section view of FIG. 2 along the AA direction. The color film substrate comprises: a basal substrate 1 (not shown in FIG. 2), a black matrix 2 and a plurality groups of color filters 3 located on the basal substrate 1 (an example with two groups of color filters is illustrated in FIG. 2), and a planarization layer 4 located on the black matrix 2 and the color filters 3 (not shown in FIG. 2); each group of color filters 3 comprises a red (R) filter, a green (G) filter, a blue (B) filter and a blank region 5 defined by the black matrix 2; the planarization layer 4 filled in the blank region 5 serves as a white (W) filter; wherein the color film substrate further comprises:

at least one linear height compensation component 6 located in the blank region 5; the height compensation component 6 and the black matrix 2 are arranged in a same layer, i.e., the height compensation component 6 and the black matrix 2 are formed by a one-time composition process with one mask plate, the material of the height compensation component 6 is same with the material of the black matrix 2. Preferably, the height of the height compensation component 6 is same with the height of the black matrix 2.

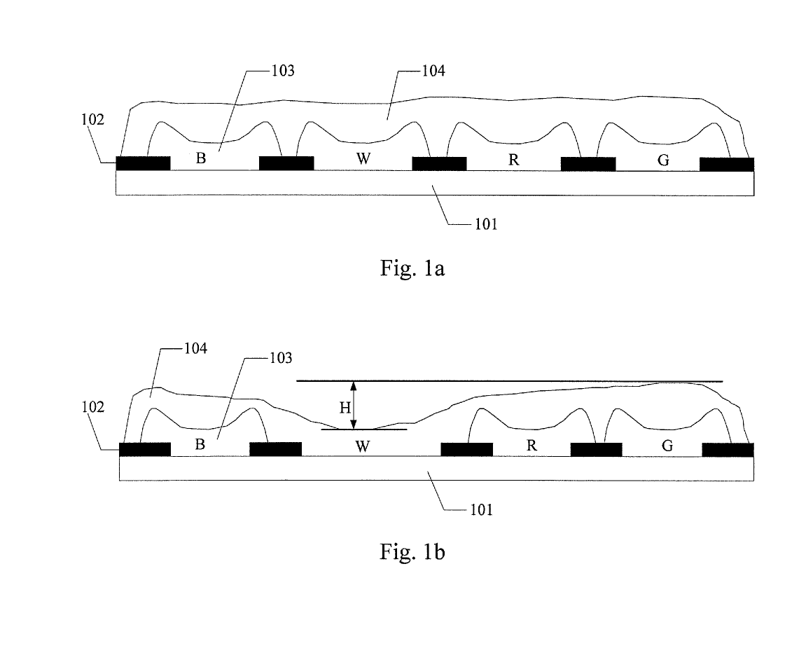

The color film substrate provided by the embodiment of the present invention applies the planarization layer filled in the blank region as a white filter. In this manner, the arrangement of the white filter does not require adding one more composition process; moreover, at least one linear height compensation component located in the blank region is added, while the height compensation component and the black matrix are arranged in a same layer, thus an additional composition process is not required; furthermore, the height compensation component can serve as a diversion dike to enhance a flow energy in the horizontal direction within the blank region for the planarization layer, thereby simplifying the manufacture process of the color film substrate with a red filter, a green filter, a blue filter and a white filter, while improving the flatness of the planarization layer. For example, the pixel segment difference H′ in the color film substrate provided by the embodiment of the present invention (as shown in FIG. 3) is apparently less than the pixel segment difference H in the color film substrate in the prior art (as shown in FIG. 1b).

In an implementation, in the color film substrate provided by the embodiment of the present invention, as shown in FIG. 3, the black matrix 2 can be arranged under the layer where the color filters 3 are located; or, the black matrix can be arranged over the layer where the color filters are located, this is not limited herein. The following embodiments only illustrate the examples in which the black matrix is arranged under the layer where the color filters are located.

In an implementation, in the color film substrate provided by the embodiment of the present invention, the shape of the linear height compensation component located in the blank region can particularly be a straight line; or, the shape of the linear height compensation component located in the blank region can particularly be a curve, this is not limited herein. In particular, the shape of the height compensation component should be arranged based on the shape of the orthographic projection of the blank region in the color film substrate on the basal substrate. Moreover, one linear height compensation component can be arranged in the blank region, or, a plurality of linear height compensation components can be arranged in the blank region, this is not limited herein. In particular, the number of the height compensation component should be arranged based on the size of the orthographic projection of the blank region in the color film substrate on the basal substrate.

In an implementation, in the color film substrate provided by the embodiment of the present invention, as shown in FIG. 2, the orthographic projections of the red (R) filter, the green (G) filter, the blue (B) filter and the blank region 5 on the basal substrate 1 are all rectangles and are arranged in an array. In such a way, the flow directions of the planarization layer 4 in the blank region 5 (indicated with the directions a, b, c and d in FIG. 2) are respectively perpendicular to the four sides of the rectangle formed by the orthographic projection of the blank region 5 on the basal substrate 1; one rectilinear height compensation component 6 can be provided in the blank region 5, thus the height compensation component 6 can serve as a diversion dike to enhance the flow energy in the directions perpendicular to the height compensation component 6 (indicated with the directions e and f in FIG. 2); since the orthographic projection of the height compensation component 6 on the basal substrate 1 is parallel to the two opposite sides in the rectangle formed by the orthographic projection of the blank region 5 on the basal substrate 1, the direction e is parallel to and opposite to the direction a, and the direction f is parallel to and opposite to the direction b. In this manner, the enhanced flow energy in the direction e can reduce the original flow energy in the direction a, and the enhanced flow energy in the direction f can reduce the original flow energy in the direction b, thereby improving the flatness of the planarization layer 4 along the directions a and b in the blank region 5.

In an implementation, in the color film substrate provided by the embodiment of the present invention, as shown in FIG. 2, the length of the added rectilinear height compensation component 6 in the blank region 5 is same with the length of the two opposite sides in the rectangle formed by the orthographic projection of the blank region 5 on the basal substrate 1, i.e., the height compensation component 6 is in contact with the black matrix 2 defining the blank region 5, in other words, the blank region 5 is divided into two regions by the height compensation component 6. In this manner, the enhanced flow energy in the directions e and f can spread all over the blank region 5, thereby improving the flatness of the planarization layer 4 along the directions a and b in the blank region 5.

In an implementation, in the color film substrate provided by the embodiment of the present invention, as shown in FIG. 2, the blank region 5 is divided into two regions with the same area by the added rectilinear height compensation component 6 in the blank region 5. In this manner, the enhanced flow energy in the direction e and the enhanced flow energy in the direction f are equal in size, thus it is ensured that the improvements on the flatness of the planarization layer 4 in these two regions are consistent, thereby improving the flatness of the planarization layer 4 along the directions a and b in the blank region 5 in a maximum extent.

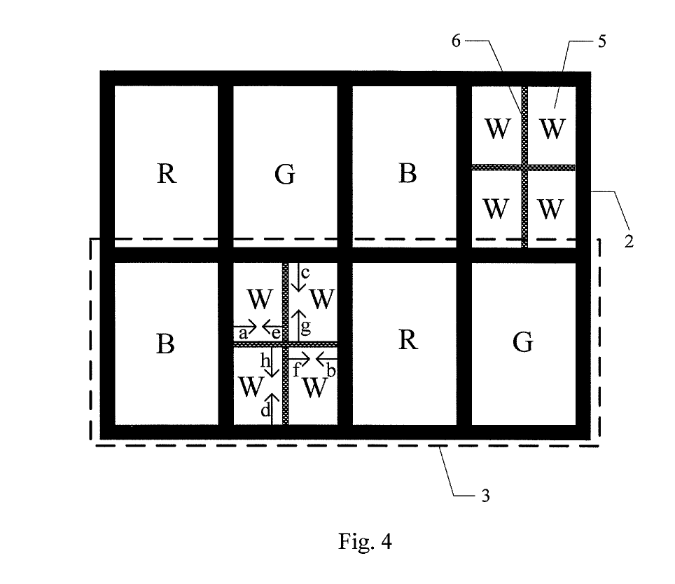

In an implementation, in the color film substrate provided by the embodiment of the present invention, as shown in FIG. 4, the orthographic projections of the red (R) filter, the green (G) filter, the blue (B) filter and the blank region 5 on the basal substrate 1 are all rectangles and are arranged in an array. In such a way, the flow directions of the planarization layer 4 in the blank region 5 (indicated with the directions a, b, c and d in FIG. 2) are respectively perpendicular to the four sides of the rectangle formed by the orthographic projection of the blank region 5 on the basal substrate 1; two rectilinear height compensation components 6 perpendicular to each other can be provided in the blank region 5, thus the height compensation components 6 can serve as diversion dikes to enhance the flow energy in the directions respectively perpendicular to the height compensation components 6 (indicated with the directions e, f, g and h in FIG. 4); since the orthographic projections of these two height compensation components 6 on the basal substrate 1 are respectively parallel to the two adjacent sides in the rectangle formed by the orthographic projection of the blank region 5 on the basal substrate 1, the direction e is parallel to and opposite to the direction a, the direction f is parallel to and opposite to the direction b, the direction g is parallel to and opposite to the direction c, and the direction h is parallel to and opposite to the direction d. In this manner, the enhanced flow energy in the direction e can reduce the original flow energy in the direction a, the enhanced flow energy in the direction f can reduce the original flow energy in the direction b, the enhanced flow energy in the direction g can reduce the original flow energy in the direction c, and the enhanced flow energy in the direction h can reduce the original flow energy in the direction d, thereby improving the flatness of the planarization layer 4 along the directions a, b, c and d in the blank region 5.

Certainly, in the color film substrate provided by the embodiment of the present invention, the orthographic projection of the added rectilinear height compensation component in the blank region on the basal substrate and any side in the rectangle formed by the orthographic projection of the blank region on the basal substrate can also form an acute angle, this is not limited herein; however, the improving effect for the flatness of the planarization layer in the blank region and the repair effect after defects are not good enough.

In an implementation, in the color film substrate provided by the embodiment of the present invention, as shown in FIG. 4, among the added two rectilinear height compensation components 6 perpendicular to each other in the blank region 5, the length of one rectilinear height compensation component 6 is equal to the length of a side parallel to the rectilinear height compensation component 6; the length of the other rectilinear height compensation component 6 is equal to the length of a side parallel to the other rectilinear height compensation component 6, i.e., the height compensation components 6 are in contact with the black matrix 2 defining the blank region 5, in other words, the blank region 5 is divided into four regions by the height compensation components 6. In this manner, the enhanced flow energy in the directions e, f, g and h can spread all over the blank region 5, thereby improving the flatness of the planarization layer 4 along the directions a, b, c and d in the blank region 5.

In an implementation, in the color film substrate provided by the embodiment of the present invention, as shown in FIG. 4, the blank region 5 is divided into four regions with the same area by the added rectilinear height compensation components 6 perpendicular to each other in the blank region 5. In this manner, the enhanced flow energy in the direction e, the enhanced flow energy in the direction f, the enhanced flow energy in the direction g, and the enhanced flow energy in the direction h are equal in size, thus it is ensured that the improvements on the flatness of the planarization layer 4 in these four regions are consistent, thereby improving the flatness of the planarization layer 4 along the directions a, b, c and d in the blank region 5 in a maximum extent.

In an implementation, in the color film substrate provided by the embodiment of the present invention, the width of the added height compensation component in the blank region is controlled to be greater than or equal to 6 In this manner, the improving effect for the flatness of the planarization layer is better.

In particular, the width of the height compensation component should be arranged based on the size of the blank region. If the width of the height compensation component is too large, it may affect a normal display of the liquid crystal display panel applying the color film substrate provided by the embodiment of the present invention; if the width of the height compensation component is too small, it may affect the improving effect for the flatness of the planarization layer. Typically, it is better to control the width of the two or four regions of the blank region divided by the height compensation component to be greater than 0 μm and less than 100 μm.

Based on the same inventive concept, an embodiment of the present invention also provides a liquid crystal display panel, wherein the liquid crystal display panel comprises: the color film substrate according to any one of the above mentioned embodiments, an array substrate arranged opposite to the color film substrate, and a liquid crystal layer between the color film substrate and the array substrate. The implementation of the liquid crystal display panel can refer to the above mentioned embodiments of the color film substrate, which are not repeated herein.

It should be noted that the color film substrate provided by the embodiment of the present invention is especially suit for large size liquid crystal display panel, since the area of the blank region in the color film substrate of the large size liquid crystal display panel is relatively large; if no height compensation component is arranged in such a blank region, the flatness problem of the planarization layer in the blank region may be severe; the improving effect for the flatness achieved by the color film substrate provided by the embodiment of the present invention is better.

Based on the same inventive concept, an embodiment of the present invention further provides a display device, wherein the display device comprises the liquid crystal display panel according to the above mentioned embodiment. The display device can be any product or component with display function, such as mobile phone, tablet computer, TV, display, notebook computer, digital photo frame, navigator and so on. The implementation of the display device can refer to the above mentioned embodiment of the liquid crystal display panel, which is not repeated herein.

In the color film substrate, the liquid crystal display panel and the display device provided by the embodiments of the present invention, the color film substrate comprises: a basal substrate, a black matrix and a plurality groups of color filters located on the basal substrate, and a planarization layer located on the black matrix and the color filters; each group of color filters comprises a red filter, a green filter, a blue filter and a blank region defined by the black matrix; the planarization layer filled in the blank region serves as a white filter; wherein the color film substrate further comprises: at least one linear height compensation component located in the blank region; the height compensation component and the black matrix are arranged in a same layer. In this manner, the arrangement of the white filter does not require adding one more composition process; moreover, at least one linear height compensation component located in the blank region is added, while the height compensation component and the black matrix are arranged in a same layer, thus an additional composition process is not required; furthermore, the height compensation component can serve as a diversion dike to enhance a flow energy in the horizontal direction within the blank region for the planarization layer, thereby simplifying the manufacture process of the color film substrate with a red filter, a green filter, a blue filter and a white filter, while improving the flatness of the planarization layer.

Apparently, the person skilled in the art may make various alterations and variations to the invention without departing the spirit and scope of the invention. As such, provided that these modifications and variations of the invention pertain to the scope of the claims of the invention and their equivalents, the invention is intended to embrace these alterations and variations.

1. A color film substrate comprising:
a basal substrate;
a black matrix;
a plurality of groups of color filters located on the basal substrate, each group of color filters comprises a red filter, a green filter, a blue filter, and a blank region defined by the black matrix;
a planarization layer located on the black matrix and the color filters; and
at least one linear height compensation component located in the blank region;
wherein the planarization layer filling in the blank region serves as a white filter; and
wherein the height compensation component and the black matrix are arranged in a same layer.

2. The color film substrate according to claim 1, wherein orthographic projections of the red filter, the green filter, the blue filter and the blank region on the basal substrate are rectangles and are arranged in an array;
wherein one rectilinear height compensation component is provided in the blank region; and
wherein the orthographic projection of the rectilinear height compensation component on the basal substrate is parallel to a first side of the orthographic projection of the blank region on the basal substrate.

3. The color film substrate according to claim 2, wherein the length of the rectilinear height compensation component is equal to the length of the first side.

4. The color film substrate according to claim 3, wherein the blank region is divided into two regions by the rectilinear height compensation component, and wherein an area of each of the two regions is equal.

5. The color film substrate according to claim 1, wherein the orthographic projections of the red filter, the green filter, the blue filter and the blank region on the basal substrate are all rectangles and are arranged in an array;
wherein two rectilinear height compensation components perpendicular to each other are provided in the blank region;
wherein the orthographic projection of a first rectilinear height compensation component on the basal substrate is parallel to a first side of the orthographic projection of the blank region on the basal substrate;
wherein the orthographic projection of a second rectilinear height compensation component on the basal substrate is parallel to a second side of the orthographic projection of the blank region on the basal substrate; and
wherein the first side and the second side are adjacent and perpendicular sides of the orthographic projection of the blank region.

6. The color film substrate according to claim 5, wherein a length of the first rectilinear height compensation component is equal to a length of the first side; and wherein a length of the second rectilinear height compensation component is equal to a length of the second side.

7. The color film substrate according to claim 6, wherein the blank region is divided into four regions by the first and second rectilinear height compensation components, and wherein an area of each of the four regions is equal.

8. The color film substrate according to claim 1, wherein a width of the height compensation component is not less than 6 μm.

9. The color film substrate according to claim 1, wherein a height of the height compensation component equal to a height of the black matrix.

10. A liquid crystal display panel comprising:
a color film substrate comprising:
a basal substrate;
a black matrix;
a plurality of groups of color filters located on the basal substrate, each group of color filters comprises a red filter, a green filter, a
blue filter, and a blank region defined by the black matrix;
a planarization layer located on the black matrix and the color filters; and
at least one linear height compensation component located in the blank region;
wherein the planarization layer filling in the blank region serves as a white filter; and
wherein the height compensation component and the black matrix are arranged in a same layer.
an array substrate arranged opposite to the color film substrate; and
a liquid crystal layer disposed between the color film substrate and the array substrate.

11. The liquid crystal display panel according to claim 10,
wherein orthographic projections of the red filter, the green filter, the blue filter and the blank region on the basal substrate are rectangles and are arranged in an array;
wherein one rectilinear height compensation component is provided in the blank region; and
wherein the orthographic projection of the rectilinear height compensation component on the basal substrate is parallel to a first side of the orthographic projection of the blank region on the basal substrate.

12. The liquid crystal display panel according to claim 11, wherein the length of the rectilinear height compensation component is equal to the length of the first side.

13. The liquid crystal display panel according to claim 12, wherein the blank region is divided into two regions by the rectilinear height compensation component, and wherein an area of each of the two regions is equal.

14. The liquid crystal display panel according to claim 10,
wherein the orthographic projections of the red filter, the green filter, the blue filter and the blank region on the basal substrate are all rectangles and are arranged in an array;
wherein two rectilinear height compensation components perpendicular to each other are provided in the blank region;
wherein the orthographic projection of a first rectilinear height compensation component on the basal substrate is parallel to a first side of the orthographic projection of the blank region on the basal substrate;
wherein the orthographic projection of a second rectilinear height compensation component on the basal substrate is parallel to a second side of the orthographic projection of the blank region on the basal substrate; and
wherein the first side and the second side are adjacent and perpendicular sides of the orthographic projection of the blank region.

15. The liquid crystal display panel according to claim 14, wherein a length of the first rectilinear height compensation component is equal to a length of the first side; and wherein a length of the second rectilinear height compensation component is equal to a length of the second side.

16. The liquid crystal display panel according to claim 15, wherein the blank region is divided into four regions by the first and second rectilinear height compensation components, and wherein an area of each of the four regions is equal.

17. The liquid crystal display panel according to claim 10, wherein a width of the height compensation component is not less than 6 μm.

18. The liquid crystal display panel according to claim 10, wherein a height of the height compensation component equal to a height of the black matrix.

19. A display device comprising:
a frame;
a color film substrate comprising:
a basal substrate;
a black matrix;
a plurality of groups of color filters located on the basal substrate, each group of color filters comprises a red filter, a green filter, a blue filter, and a blank region defined by the black matrix;
a planarization layer located on the black matrix and the color filters; and
at least one linear height compensation component located in the blank region;
wherein the planarization layer filling in the blank region serves as a white filter; and
wherein the height compensation component and the black matrix are arranged in a same layer.
an array substrate arranged opposite to the color film substrate; and
a liquid crystal layer disposed between the color film substrate and the array substrate.
